(19) United States
(12) Patent Application Publication
(10) Pub. No.: US 2010/0226620 A1
(43) Pub. Date: Sep. 9, 2010

(54) Method For Incorporating A Soundtrack Into An Edited Video-With-Audio Recording And An Audio Tag

(75) Inventor: Wong Hoo Sim, Singapore (SG)

Correspondence Address: CREATIVE LABS, INC.;LEGAL DEPARTMENT, 1901 MCCARTHY BLVD, MILPITAS, CA, 95035, US

(73) Assignee: CREATIVE TECHNOLOGY LTD, Singapore (SG)

(21) Appl. No.: 12/676,882

(22) PCT Filed: Sep. 5, 2008
(86) PCT No.: PCT/SG2008/000332

§ 371 Date: Mar. 5, 2010

(30) Foreign Application Priority Data
Sep. 5, 2007 (SG) 200706527-9

(51) Int. Cl. H04N 5/93

(52) U.S. Cl. 386/54; 386/E05.003

(57) ABSTRACT

There is provided a method for incorporating a soundtrack into an edited video-with-audio recording using a video recording apparatus. The method includes recording the video-with-audio for subsequent playback. Subsequently, at least one soundtrack is incorporated as an audio tag, the at least one soundtrack being selected from a plurality of soundtracks generated from a soundtrack creator dependent on conditions such as, for example, parameters of content of the recorded video-with-audio, user-defined characteristics for the at least one soundtrack, or a combination of both of the aforementioned conditions. Content of the video-with-audio incorporated with the selected soundtrack is reviewed. The user may edit the content of video-with-audio incorporated with the selected soundtrack by removing image frames of the video-with-audio; and rectify the selected soundtrack using the soundtrack creator such that the edited video-with-audio has a fluent soundtrack similar to the selected soundtrack. The edited video-with-audio is thus enhanced in relation to aural effects in a desired manner by the user. In another aspect, there is provided an audio tag used to generate a soundtrack in a video-with-audio using a soundtrack creator.

### FIELD OF INVENTION

The present invention relates to a method for incorporating a soundtrack into a video recording, primarily to that of an edited video recording. The present invention also relates to an audio tag used in the aforementioned method.

### BACKGROUND

In this age of the information highway where sharing of information is prevalent, the popularity of devices capable of recording video recordings has steadily increased. It is likely that the popularity of such devices will increase at an even faster rate once data transmission bandwidths are able to cope with transmissions of high volumes of video data.

While these devices possess one or several audio inputs which permit mixing or replacement of the soundtrack that was recorded originally during the recording of the image with an external audio source, editing the recorded video generally requires specialized software such as, for example, Videostudio from ULead, Win DVD Creator from Intervideo, Powerdirector from Cyberlink and the like. The aforementioned software may also require training over time for a user to gain a degree of competence in using the software, time and effort which users may not be willing to commit.

As such, users who prefer to use as little time and effort as possible to record and edit certain aspects of their video content have few options available to them. This is especially critical for users who wish to post “live” near instantaneous video-blog entries.

### SUMMARY

There is provided a method for incorporating a soundtrack into an edited video-with-audio recording using a video recording apparatus. The method includes recording the video-with-audio for subsequent playback. Subsequently, at least one soundtrack is incorporated as an audio tag, the at least one soundtrack being selected from a plurality of soundtracks generated from a soundtrack creator dependent on conditions such as, for example, parameters of content of the recorded video-with-audio, user-defined characteristics for the at least one soundtrack, or a combination of both of the aforementioned conditions. Content of the video-with-audio incorporated with the selected soundtrack is reviewed. The user may edit the content of video-with-audio incorporated with the selected soundtrack by removing image frames of the video-with-audio; and rectify the selected soundtrack using the soundtrack creator such that the edited video-with-audio has a fluent soundtrack similar to the selected soundtrack. The edited video-with-audio is thus enhanced in relation to aural effects in a desired manner by the user.

The method may also include prevention of tampering to the selected soundtrack incorporated with the video-with-audio.

It is advantageous that the soundtrack creator is able to perform tasks aiding in a creation of the audio tag, the tasks being, for example, output an original composition for use as a soundtrack using stored sound samples, output at least one stored digitized musical files as a soundtrack, or a combination of the aforementioned tasks. The digitized musical files may include file types such as, for example, MP3, WMA, OGG, MID, WAV and AAC. Incorporating the selected soundtrack may involve either replacement of all audio in recorded content of the video-with-audio or combining audio in recorded content of the video-with-audio with the selected soundtrack.

The parameters of content include, for example, level of lighting in content of recorded video-with-audio, volume level of audio in content of recorded video-with-audio, density of audio in content of recorded video-with-audio, movement of subjects in content of recorded video-with-audio, or any combination of the aforementioned parameters.

Rectification of the selected soundtrack may involve the soundtrack creator performing the steps of identifying gaps in the selected soundtrack and adapting/assessing fluency of the selected soundtrack. The duration of the rectified selected soundtrack may preferably be similar to a duration of the edited video-with-audio. It is preferable that adapting the soundtrack involves the soundtrack creator performing tasks like stretching/compressing the soundtrack, increasing/decreasing the number of loops of the soundtrack, and re-combination of sound samples. It is advantageous that the aural effects emphasise a mood and ambience of the content of the edited video-with-audio during playback.

The audio tag may be stored separately from audio content of the video-with-audio to facilitate editing of the content of the video-with-audio. The audio tag may preferably be defined by a series of alphanumeric code that represent characteristics of the selected soundtrack, characteristics such as, for example, mood, ambience, or beat frequency. The characteristics may preferably be input using a user interface which converts the characteristics into the series of alphanumeric code. The alphanumeric code may preferably be readable by the soundtrack creator.

It is advantageous that a recipient may able to vary the selected soundtrack when the recipient has either remote or local access to the soundtrack creator.

In another aspect, there is provided an audio tag used to generate a soundtrack in a video-with-audio using a soundtrack creator.

### DESCRIPTION OF DRAWINGS

In order that the present invention may be fully understood and readily put into practical effect, there shall now be described by way of non-limitative example only preferred embodiments of the present invention, the description being with reference to the accompanying illustrative drawings.

FIG. 1 shows a process flow of a preferred embodiment of the method of the present invention.

FIG. 2 shows a process flow of a soundtrack creator as employed in several aspects in the preferred embodiment.

### DESCRIPTION OF PREFERRED EMBODIMENTS

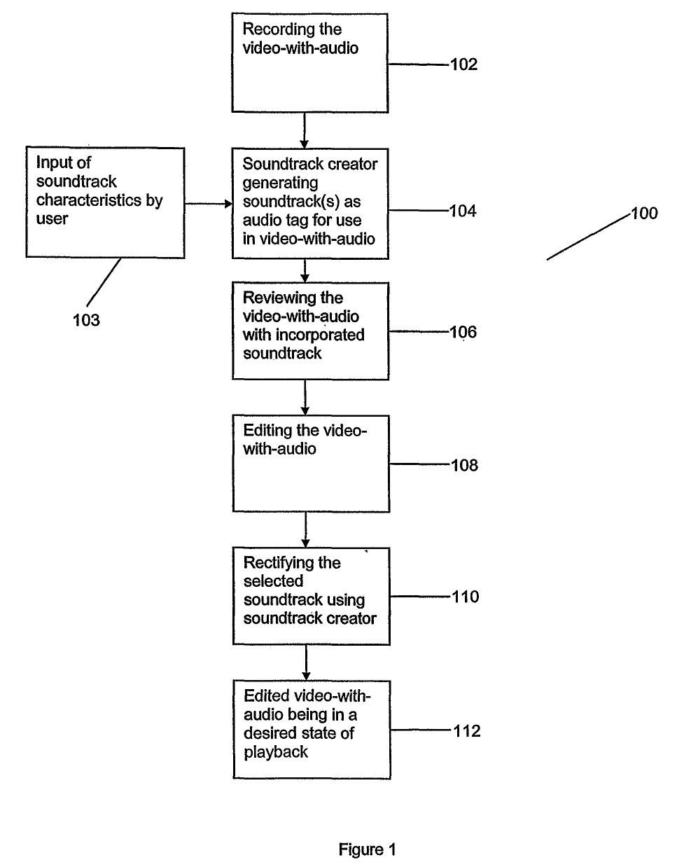

Referring to FIG. 1, there is provided a method 100 for incorporating a soundtrack into an edited video-with-audio recording using a video recording apparatus. It should be noted that the editing of the video-with-audio recording may also be done on a PC. The method 100 includes recording the video-with-audio for subsequent playback (102). It should be noted that video-with-audio also includes capturing a series of moving images with sound being muted during recording. The video-with-audio may be captured using multiple streams, with separate streams for images and audio. Alternatively, the video-with-audio may be captured as a single stream which includes both images and audio. The method 100 may be applied to both of the aforementioned forms of video-with-audio.

Subsequently, a soundtrack may be incorporated into the video-with-audio (104). The soundtrack may aid in emphasising a mood and/or ambience of content of the video-with-audio after incorporation into the video-with-audio. A plurality of soundtracks may be generated by a soundtrack creator.

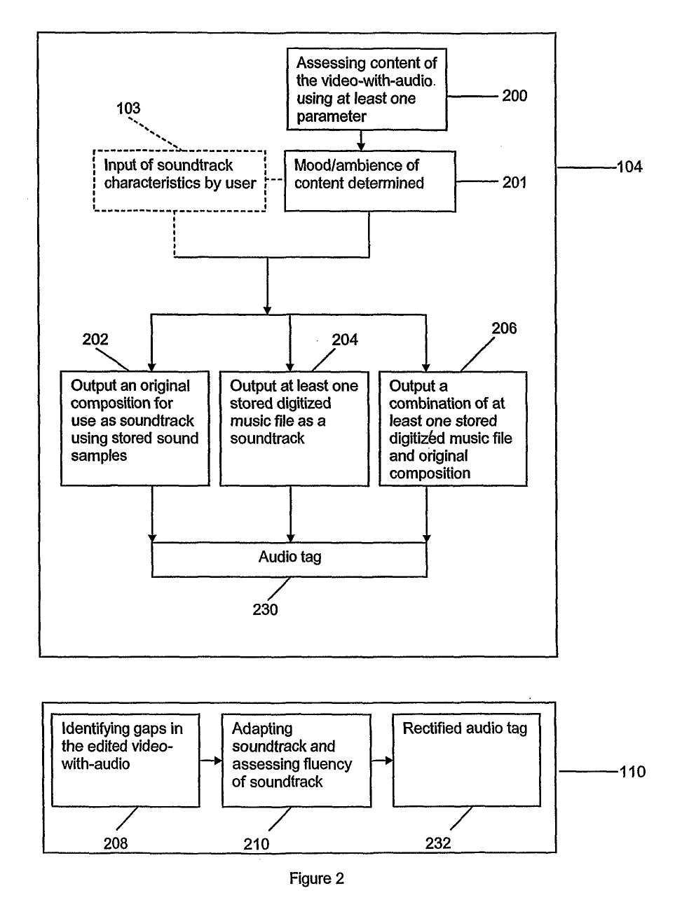

Referring to FIG. 2, there is shown a process in relation to how the plurality of soundtracks is generated from the soundtrack creator when assessing parameters of the content of the video-with-audio. Firstly, the soundtrack creator assesses content on the recorded video-with-audio (200). The soundtrack creator may be able to assess both single and multiple stream videos. The recorded video-with-audio is assessed using parameters such as, for example:

level of lighting in content of recorded video-with-audio;

volume level of audio in content of recorded video-with-audio;

density of audio in content of recorded video-with-audio;

movement of subjects in content of recorded video-with-audio; and

any combination of the aforementioned parameters.

Generally, if the level of lighting detected in the content is higher than a pre-determined level, the soundtrack creator may generate a soundtrack with an upbeat rhythm. Correspondingly, if the level of lighting detected in the content is lower than the pre-determined level, the soundtrack creator may generate a soundtrack with a sombre rhythm.

Similarly, if the volume level/density of audio in the content is higher than a pre-determined level, the soundtrack creator may generate a soundtrack with an upbeat rhythm. Correspondingly, if the volume level/density of audio detected in the content is lower than the pre-determined level, the soundtrack creator may generate a soundtrack with a sombre rhythm.

The soundtrack creator may also utilize digital imaging technology such as, for example, face recognition technology, pixel agglomeration technology and the like to detect movement of subjects in the content of recorded video-with-audio. Generally, if vigorous movements are detected, the soundtrack creator may generate a soundtrack with an upbeat rhythm. Correspondingly, if few movements of subjects in the content are detected, the soundtrack creator may generate a soundtrack with a sombre rhythm.

It should be noted that the soundtrack creator is not only able to generate soundtracks with upbeat and sombre rhythms. The aforementioned are merely examples used to aid in understanding the preferred embodiment. Other rhythms such as, for example, frantic, relaxed, inspirational and so forth may also be generated by the soundtrack creator.

The soundtrack creator may have a capability to output an original composition as a soundtrack using stored sound samples (202), output at (east one stored digitized musical file as a soundtrack (204), or output an original composition which combines stored sound samples and at least one stored digitized musical file (206). The digitized musical files may include file types such as, for example, MP3, WMA, OGG, MID, WAV, AAC and so forth. The digitized musical files may include short musical loops which may be repeated, stretched, and compressed. Each soundtrack may be stored as an audio tag (230). The soundtrack creator may provide several soundtracks for selection, each of which may be previewed on the video recording apparatus by a user subsequent to incorporation with the video-with-audio before a soundtrack is selected for definitive incorporation with the video-with-audio (106). Incorporating the selected soundtrack may involve either replacement of all audio in the recorded video-with-audio or combining (mixing) audio in the recorded video-with-audio with the selected soundtrack. The selected soundtrack may be stored separately from audio content of the video-with-audio to facilitate editing of the content of the video-with-audio at a later time. Storing the selected soundtrack separately may also enable removal of the selected soundtrack. This may depend on a preference of the user.

The audio tag may be defined by a series of alphanumeric codes that represent characteristics of the selected soundtrack, such as, for example, mood, ambience, beat frequency and the like. The alphanumeric code may be a nine digit arrangement of alphabets and numerals, such as, “abc 456 t5i”, where the first three characters represent the mood, the middle three characters represent the ambience, and the final three characters represent the beat frequency. The alphanumeric code of the audio tag is readable by the soundtrack creator to aid in the generation of a soundtrack. This ensures that anyone with access to the soundtrack creator will have a capability to generate a soundtrack for a video-with-audio with an audio tag. The user need not know the alphanumeric code or a form of conversion per se, as the alphanumeric code represents a means to quantify non-quantifiable objects like mood and ambience. For example, “abc” may mean “sleepy mood”, “456” may mean “celebratory occasion” and so forth. The conversion may be performed using a user interface which the user interacts with. The user may be able to use the user interface to input the terms “sleepy mood” and “celebratory occasion” and the conversion into alphanumeric code is correspondingly performed for input into the soundtrack creator. It should be noted that this nine digit arrangement of characters is not meant to be limiting as it is merely an illustrative example.

The user may input soundtrack characteristics (103) into the soundtrack creator such that output from the soundtrack creator is similar to what the user desires. A presence of the audio tag may aid the user in ensuring that any particular characteristic which is mandatory for the soundtrack of the video-with-audio would be taken into account by the soundtrack creator. More than one audio tag may be incorporated into the content of the video-with-audio as the mood and/or ambience of the content may vary, so a single audio tag may not be suitable for an entire content. Each audio tag may be defined to be invoked at a specific point in time during playback. Alternatively, each audio tag may include more than one soundtrack, and each soundtrack may be defined to be invoked at a specific point in time during playback.

Subsequently, the user may edit the content of the video-with-audio incorporated with the selected soundtrack by removing portions such as bad takes or unwanted scenes from the content of the video-with-audio (108).

Consequently, the soundtrack creator may rectify the selected soundtrack such that the edited video-with-audio has a fluent soundtrack similar to the selected soundtrack (110). Referring back to FIG. 2, rectifying the selected soundtrack may involve the soundtrack creator identifying gaps in the selected soundtrack (208) caused by removal of portions of content of the video-with-audio. It is likely that the removal of portions of content would cause a loss in fluency of the selected soundtrack. In order to maintain fluency of the selected soundtrack, the soundtrack creator may perform adaptation tasks (210) such as, for example stretch/compress the soundtrack, increase/decrease the number of loops of the soundtrack, re-combination of sound samples and so forth. A duration of the rectified selected soundtrack may be similar to a duration of the edited video-with-audio, and this correspondingly also maintains mood and/or ambience of the content. Rectification of the selected soundtrack may also be reflected in the audio tag (232).

The use of the audio tag allows the edited video-with-audio to be customized by either a maker of the video-with-audio (the user of the video recording apparatus) or a receiver/recipient of the edited video-with-audio. The receiver/recipient would be able to customize the selected soundtrack to their preference if there was a presence of the soundtrack creator on the device which is used to consume the edited video-with-audio. It should be noted that the soundtrack creator may be accessed remotely by the device and need not be installed in the device. The presence of the audio tag which contains information from the maker pertaining to any particular characteristic which is mandatory for the soundtrack of the video-with-audio may ensure that the soundtrack creator would not generate unsuitable soundtracks for selection.

The maker may also have an option of restricting rights of the receiver/recipient to tamper with any aspect of the edited video-with-audio, regardless of whether the receiver/recipient has access to the soundtrack creator. This measure may be implemented to preserve a style, ambience and mood as originally intended by the maker.

It should be the noted that the audio tag mentioned in the preceding paragraphs is another aspect of the present invention.

Whilst there has been described in the foregoing description preferred embodiments of the present invention, it will be understood by those skilled in the technology concerned that many variations or modifications in details of design or construction may be made without departing from the present invention.

1. A method for incorporating a soundtrack into an edited video-with-audio recording using a video recording apparatus, the method including:
recording the video-with-audio for subsequent playback;
incorporating at least one soundtrack as an audio tag, the at least one soundtrack selected from a plurality of soundtracks, the plurality of soundtracks being generated from a soundtrack creator that depends on conditions selected from a group consisting of: parameters of content of the recorded video-with-audio, user-defined characteristics for the at least one soundtrack, and a combination of both of the aforementioned conditions;
reviewing content of the video-with-audio which is incorporated with the selected soundtrack;
editing the content of video-with-audio incorporated with the selected soundtrack by removing image frames of the video-with-audio; and
rectifying the selected soundtrack using the soundtrack creator such that the edited video-with-audio has a fluent soundtrack similar to the selected soundtrack,
wherein the edited video-with-audio is enhanced in relation to aural effects in a desired manner by the user.

2. The method as claimed in claim 1, wherein the soundtrack creator is able to perform tasks aiding in a creation of the audio tag, the tasks selected from the group consisting of: output an original composition for use as a soundtrack using stored sound samples, output at least one stored digitized musical files as a soundtrack, and a combination of the aforementioned tasks.

3. The method as claimed in claim 2, wherein the digitized musical files include file types selected from the group consisting of: MP3, WMA, OGG, MID, WAV and AAC.

4. The method as claimed in claim 1, wherein the parameters are selected from the group consisting of: level of lighting in content of recorded video-with-audio, volume level of audio in content of recorded video-with-audio, density of audio in content of recorded video-with-audio, movement of subjects in content of recorded video-with-audio, and any combination of the aforementioned parameters.

5. The method as claimed in claim 1, wherein incorporating the selected soundtrack involves either replacement of all audio in recorded content of the video-with-audio or combining audio in recorded content of the video-with-audio with the selected soundtrack.

6. The method as claimed in claim 1, wherein rectifying the selected soundtrack involves the soundtrack creator performing the steps of:
identifying gaps in the selected soundtrack; and
adapting and assessing fluency of the selected soundtrack;
wherein a duration of the rectified selected soundtrack is similar to a duration of the edited video-with-audio.

7. The method as claimed in claim 1, wherein the aural effects emphasise a mood and ambience of the content of the edited video-with-audio during playback.

8. The method as claimed in claim 6, wherein the adapting of the soundtrack involves the soundtrack creator performing tasks selected from the group consisting of: stretch/compress the soundtrack, increase/decrease the number of loops of the soundtrack, and re-combination of sound samples.

9. The method as claimed in claim 1, wherein the audio tag is stored separately from audio content of the video-with-audio to facilitate editing of the content of the video-with-audio.

10. The method as claimed in claim 9, wherein the audio tag is defined by a series of alphanumeric code that represent characteristics of the selected soundtrack, the characteristics selected from the group consisting of: mood, ambience, and beat frequency.

11. The method as claimed in claim 1, further including preventing tampering to the selected soundtrack incorporated with the video-with-audio.

12. The method as claimed in claim 10, wherein the characteristics are input using a user interface which converts the characteristics into the series of alphanumeric code.

13. The method as claimed in claim 9, wherein the alphanumeric code is readable by the soundtrack creator.

14. The method as claimed in claim 1, wherein a recipient is able to vary the selected soundtrack when the recipient has access to the soundtrack creator.

15. The method as claimed in claim 14, wherein the access is either remote or local.

16. An audio tag used to generate a soundtrack in a video-with-audio using a soundtrack creator of the method of claim 1.
